(19) United States
(12) Patent Application Publication
(10) Pub. No.: US 2026/0049190 A1
(43) Pub. Date: Feb. 19, 2026

(54) HEAT-RESISTANT LIQUID CRYSTAL POLYMER FILM

(71) Applicant: TAIMIDE TECHNOLOGY INCORPORATION, Hsinchu Hsien (TW)

(72) Inventors: CHENG-CHENG TSAI, Hsinchu Hsien (TW); CHIA-HSUN HSIEH, Hsinchu Hsien (TW); YI-HSUEH HO, Hsinchu Hsien (TW)

(73) Assignee: TAIMIDE TECHNOLOGY INCORPORATION, Hsinchu Hsien (TW)

(21) Appl. No.: 18/808,112

(22) Filed: Aug. 19, 2024

(51) Int. Cl. C08J 5/18; C08G 73/14

(52) U.S. Cl. CPC C08J 5/18; C08G 73/14; C08J 2333/24

(57) ABSTRACT

A heat-resistant liquid crystal polymer film includes a soluble liquid crystal polymer, accounting for 15-75 wt % of the heat-resistant liquid crystal polymer film; an insoluble liquid crystal polymer, accounting for 15-75 wt % of the heat-resistant liquid crystal polymer film; and a polyimide, composed of dianhydride and diamine, which accounts for 10-50 wt % of the heat-resistant liquid crystal polymer film, and the polyimide has a glass transition temperature greater than 250° C., wherein the heat-resistant liquid crystal polymer film has a moisture absorption less than 0.5%, and has a dielectric loss less than 0.005 under the condition of frequency of 10 GHz and humidity of 65% RH; also, under the condition of 50-200° C., the heat-resistant liquid crystal polymer film has a linear thermal expansion coefficient less than 20 ppm/° C.; under the condition of 310° C., the heat-resistant liquid crystal polymer film has a storage modulus greater than 0.2 Gpa, and has a glass transition temperature greater than 220° C.

### BACKGROUND OF THE INVENTION

### 1. Field of the Invention

The present disclosure relates to a heat-resistant liquid crystal polymer film, and in particular to a heat-resistant liquid crystal polymer film having good dielectric properties and preferable temperature resistance and low expansion coefficient under a high moisture absorption condition, and can be applied in the field of high-frequency and high-speed transmission.

### 2. Description of the Related Art

The prior art of Taiwan patent publication No. I786659 discloses a composite film including a soluble liquid crystal polymer, an insoluble liquid crystal polymer and a polyimide, which uses a lower proportion of polyimide to make the composite film have excellent dielectric properties and operability in the back-end process of FCCL and FPC.

### BRIEF SUMMARY OF THE INVENTION

However, in the traditional composite film, the good heat resistance and mechanical properties mainly come from a higher proportion of polyimide, but the polyimide used is mainly polyimide containing ester groups, and the dielectric properties of this polyimide are poor. It can be seen that a higher proportion of polyimide containing ester groups will limit the further optimization of this composite film, making it difficult to have better dielectric properties, heat resistance and mechanical properties.

The present disclosure provides a heat-resistant liquid crystal polymer film, which includes a soluble liquid crystal polymer, accounting for 15-75 wt % of the heat-resistant liquid crystal polymer film; an insoluble liquid crystal polymer, accounting for 15-75 wt % of the heat-resistant liquid crystal polymer film; and a polyimide, composed of dianhydride and diamine, which accounts for 10-50 wt % of the heat-resistant liquid crystal polymer film, and the polyimide has a glass transition temperature (Tg) greater than 250° C., wherein the heat-resistant liquid crystal polymer film has a moisture absorption less than 0.5%; under the condition of frequency of 10 GHz and humidity of 65 % RH, the heat-resistant liquid crystal polymer film has a dielectric loss (Df) less than 0.005; as well as, under the condition of 50-200° C., the heat-resistant liquid crystal polymer film has a linear thermal expansion coefficient (CTE) less than 20 ppm/° C.; under the condition of 310° C., the heat-resistant liquid crystal polymer film has a storage modulus (E′) greater than 0.2 Gpa; and, the heat-resistant liquid crystal polymer film has a glass transition temperature (Tg) greater than 220° C.

### DETAILED DESCRIPTION OF THE INVENTION

A heat-resistant liquid crystal polymer film of the present disclosure includes a soluble liquid crystal polymer and an insoluble liquid crystal polymer and a polyimide.

The soluble liquid crystal polymer is soluble in an organic solvent, the organic solvent may be at least one group consisting of dimethylacetamide (DMAc), N-methyl-pyrrolidone (NMP), N-ethyl-2-pyrrolidone (NEP), γ-butyrolactone (GBL) and N,N-dimethylformamide (DMF), and the solubility is 5 wt % or more, it is preferably 8 wt % or more, more preferably 10 wt % or more.

The soluble liquid crystal polymer accounts for 15 wt % to 75 wt % of the heat-resistant liquid crystal polymer film.

The insoluble liquid crystal polymer accounts for 15 wt % to 75 wt % of the heat-resistant liquid crystal polymer film.

The insoluble liquid crystal polymer has a dielectric loss (Df) less than 0.001, it is preferably less than 0.0009, more preferably less than 0.0008.

The form of the insoluble liquid crystal polymer may be powder, and the 50% cumulative particle size (D50) of the particle size distribution is less than 20 μm, and 99% cumulative particle size (D99) is less than 2.5 times the D50.

The form of the insoluble liquid crystal polymer is powder, a water absorption rate is preferably less than 0.5%, more preferably less than 0.05%.

The polyimide accounts for 10-50 wt % of the heat-resistant liquid crystal polymer film, and the glass transition temperature (Tg) of the polyimide is preferably greater than 250° C., and more preferably greater than 300° C.

The heat-resistant liquid crystal polymer film has the following characteristics: moisture absorption is less than 0.5%; under the condition that the frequency is 10 GHz and the humidity is 65% RH, the dielectric loss (Df) is less than 0.005; the coefficient of linear thermal expansion (CTE) is less than 20 ppm/° C. at 50-200° C.; the storage modulus (E′) at 310° C. is greater than 0.2 Gpa; and glass transition temperature (Tg) is greater than 220° C.

Among them, the constituent monomer of the polyimide includes pyromellitic dianhydride, which is 20-80 mol % relative to the total dianhydride.

Other dianhydrides, such as 3,3′,4,4′-biphenyl tetracarboxylic dianhydride, p-phenylenebis (trimellitate anhydride) and 4,4′-oxodiphthalic anhydride, may also be added as necessary.

The diamine constituent monomer of the polyimide includes p-phenylenediamine, which accounts for 40-60 mol % of the total diamine. In addition, the diamine of the polyimide preferably includes p-phenylenediamine and a combination with the following diamines: 1,3-bis(4′-aminophenoxy)benzene, 1,4-bis(4-aminophenoxy)benzene, 2,2′-bis [4-(4-aminophenoxyphenyl)]propane, 4,4′-bis(4-aminophenoxy)biphenyl, 1,3-bis(3-aminophenoxy)benzene, p-aminophenyl p-aminobenzoate, 2,2′-bis(trifluoromethyl)diaminobiphenyl and 4,4′-diaminodiphenyl ether.

Next, the soluble liquid crystal polymer, insoluble liquid crystal polymer and polyamic acid are mixed and appropriately diluted, the curing catalyst is added, and after centrifugal defoaming, it is coated on glass or other metal substrates, and then baked at 60-80° C. for 40-120 minutes to form a gel film. The gel film is taken down from the substrate and fixed to a metal frame, where it is baked at 300° C. for 60 minutes before forming. The baking temperature is preferably greater than 300° C. and more preferably greater 320° C.

The heat-resistant liquid crystal polymer film of the present disclosure is cured by chemical catalysis. The catalysts can be pyridine, 3-methylpyridine, 2-methylpyridine, 4-methylpyridine, isoquinoline, quinoline and triethylamine, and the preferable catalysts are pyridine, 3-methylpyridine, 2-methylpyridine and 4-methylpyridine. In the present disclosure, 3-methylpyridine may be selected as a catalyst, and the dehydrating agent may be acetic anhydride.

The heat-resistant liquid crystal polymer film of the present disclosure may also be added with other types of inorganic fillers or organic fillers according to the functional requirements. The organic fillers, for example, may be fluoropolymers, such as polytetrafluoroethylene (PTFE), a copolymer of tetrafluoroethylene and perfluoroalkyl vinyl ether (PFA) to reduce the dielectric coefficient. In addition, the addition of organic polymers containing phospholipids or inorganic fillers, such as silica and alumina can improve antistatic properties and temperature resistance. In addition, fillers containing alkynes or silanes may be added to improve surface adhesion.

The present disclosure may be applied to a flexible circuit substrate, including an insulating material and a covering film, especially the insulating material is preferred. For example, it may be applied to a metal laminate board, which includes at least one layer of laminate and a heat-resistant liquid crystal polymer film of the present disclosure, and may also include a metal layer, a heat-resistant liquid crystal polymer film of the present disclosure and an adhesive layer between the metal layer and the heat-resistant liquid crystal polymer film.

There is no specific restriction on the material of the metal layer, and a single metal, such as copper, nickel, aluminum and silver or an alloy of the above metals may be used, the most preferable one of these is copper. The layer of laminate may be thermoplastic, general polyimide or epoxy resin, preferably thermoplastic polyimide with low dielectric loss, or epoxy resin with low dielectric loss.

The present disclosure is specified according to the embodiments, but the

present disclosure is not limited thereto. Furthermore, the details of the raw materials indicated in abbreviation in each embodiment are presented below.

Monomers constituting polyimide:
3,3′,4,4′-biphenyl tetracarboxylic dianhydride: BPDA
pyromellitic dianhydride: PMDA
p-phenylenediamine: PDA
1,3-bis (4′-aminophenoxy) benzene: TPER
2,2′-bis (trifluoromethyl) diaminobiphenyl: TFMB
4,4′-diaminodiphenyl ether: 4,4′-ODA or ODA
2,2′-dimethyl-4,4′-diaminobiphenyl: m-TB
Insoluble liquid crystal polymers (LCPs): LF-31P liquid crystal polymer powder, developed and manufactured by ENEOS.
Soluble liquid crystal polymer (LCPv): liquid crystal polymer slurry, developed and manufactured by ITRI.

### Solvent

DMAc: Dimethylacetamide
AA: acetic anhydride
AP: 3-methylpyridine

### Detection Method

The properties of the heat-resistant liquid crystal polymer film obtained in the following embodiment are measured by using the following method.

Moisture absorption: it is measured by using a digital hygrometer (model DTM-301H) produced by TECPEL, the results displayed are used as experimental results.

Dielectric loss: according to ASTM D2520 standard method, the E5071C network analyzer manufactured by Agilent is used, and a resonant cavity represented by Veritas Technologies, Inc is used. The measurement is carried out at a relative humidity of 65% RH or 100% RH and a frequency of 10 GHz. It is measured three times and the average value is taken as the actual value.

Linear expansion coefficient (50-200° C.): it is measured by using an instrument with model Q400 TMA produced by TA Instrument according to ASTM D696 standard test method. The temperature range measured is 50-200° C., and the heating rate is set to 10° C./min. First, the residual membrane stress is eliminated through the first measurement, and the second measurement result is taken as the experimental result.

Storage modulus of elasticity (E′): the storage modulus of elasticity at a temperature of 310° C. is measured using a DMA25 instrument produced by Metravib company. The rest of the measurement conditions are as follows:
Sample measurement range: width 15 mm, fixture spacing 20 mm
Temperature setting range: 30-400° C.
Heating rate: 10° C./min
Dynamic force: 100 mN
Static force: 1N
Frequency: 5 Hz

Glass transition temperature (Tg): it is measured by using a DMA25 instrument produced by Metravib company, the measurement conditions of the instrument are the same as those used to measure the storage modulus of elasticity. The temperature corresponding to the peak value of the loss tangent is defined as the glass transition temperature.

### EMBODIMENT 1

1.4 g of PDA and 3.1 g of TPER were added to 49.2 g of solvent DMAc, stirred and dissolved evenly, and then 1.8 g of PMDA and 4.5 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. Then, 15.0 g of polyimide precursor, 15.4 g of soluble liquid crystal polymer and 3.5 g of insoluble liquid crystal polymer with 10% solid content were mixed and stirred evenly. A mixture of catalyst and dehydrating agent was added to the mixed solution, and the mixture was composed of 2.4 g of AA and 2.2 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### EMBODIMENT 2

60 g of polyimide precursor was polymerized by adding 1.1 g of PDA and 3.6 g of TPER to 49.2 g of solvent DMAc, stirring and dissolving evenly, and then 1.2 g of PMDA and 4.9 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. Then, 15.0 g of polyimide precursor, 15.4 g of soluble liquid crystal polymer and 3.5 g of insoluble liquid crystal polymer with 10% solid content were mixed and stirred evenly. A mixture of catalyst and dehydrating agent was added to the mixed solution, and the mixture was composed of 2.3 g of AA and 2.1 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### EMBODIMENT 3

0.94 g of PDA, 1.3 g of TPER and 2.8 g of TFMB were added to 49.2 g of solvent DMAc, stirred and dissolved evenly, and then 1.7 g of PMDA and 4.2 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 15.4 g of soluble liquid crystal polymer and 3.5 g of insoluble liquid crystal polymer with 10% solid content were mixed and stirred evenly. A mixture of catalyst and dehydrating agent was added to the mixed solution, and the mixture was composed of 2.2 g of AA and 2.0 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### EMBODIMENT 4

1.6 g of PDA, 1.5 g of TPER and 1.0 g of 4,4-ODA were added to 49.2 g of

solvent DMAc, stirred and dissolved evenly, and then 1.9 g of PMDA and 4.8 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 15.4 g of soluble liquid crystal polymer and 3.5 g of insoluble liquid crystal polymer with 10% solid content were mixed and stirred evenly. A mixture of catalyst and dehydrating agent was added to the mixed solution, and the mixture was composed of 2.6 g of AA and 2.3 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### EMBODIMENT 5

0.94 g of PDA, 1.3 g of TPER and 2.8 g of TFMB were added to 49.2 g of solvent DMAc, stirred and dissolved evenly, and then 1.7 g of PMDA and 4.2 g of

BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 27.0 g of soluble liquid crystal polymer slurry and 1.4 g of insoluble liquid crystal polymer powder with 10% solid content were mixed and stirred evenly. A mixture of catalyst and dehydrating agent was added to the mixed solution, and the mixture was composed of 2.2 g of AA and 2.0 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### EMBODIMENT 6

0.94 g of PDA, 1.3 g of TPER and 2.8 g of TFMB were added to 49.2 g of solvent DMAc, stirred and dissolved evenly, and then 1.7 g of PMDA and 4.2 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 22.5 g of soluble liquid crystal polymer and 10.1 g of insoluble liquid crystal polymer with 10% solid content were mixed and stirred evenly. A mixture of catalyst and dehydrating agent was added to the mixed solution, and the mixture was composed of 2.2 g of AA and 2.0 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### COMPARATIVE EXAMPLE 1

1.4 g of PDA and 3.0 g of TPER were added to 49.2 g of solvent DMAc, stirred and dissolved evenly, and then 0.75 g of PMDA and 5.7 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 15.4 g of soluble liquid crystal polymer slurry and 3.5 g of insoluble liquid crystal polymer powder with 10% solid content were mixed and stirred evenly. A mixture of catalyst and dehydrating agent was added to the mixed solution, and the mixture was composed of 2.3 g of AA and 2.1 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### COMPARATIVE EXAMPLE 2

1.5 g of PDA, 2.4 g of TPER and 0.83 g of m-TB were added to 49.2 g of solvent DMAc, stirred and dissolved evenly, and then 4.7 g of PMDA and 1.4 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 15.4 g of soluble liquid crystal polymer slurry and 3.5 g of insoluble liquid crystal polymer powder with 10% solid content were mixed and stirred evenly. A mixture of catalyst and dehydrating agent was added to the mixed solution, and the mixture was composed of 2.3 g of AA and 2.1 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### COMPARATIVE EXAMPLE 3

1.7g of PDA and 2.5 g of TPER were added to 49.2 g of solvent DMAc, stirred and dissolved evenly, and then 1.9 g of PMDA and 4.7 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 15.4 g of soluble liquid crystal polymer slurry and 3.5 g of insoluble liquid crystal polymer powder with 10% solid content were mixed and stirred evenly. A mixture of catalyst and dehydrating agent was added to the mixed solution, and the mixture was composed of 2.3 g of AA and 2.1 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### COMPARATIVE EXAMPLE 4

0.64 g of PDA, 3.4 g of TPER and 0.88 g of ODA were added to 49.2 g of

solvent DMAc, stirred and dissolved evenly, and then 1.7 g of PMDA and 4.2 g of

BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 15.4 g of soluble liquid crystal polymer slurry and 3.5 g of insoluble liquid crystal polymer powder with 10% solid content were mixed and stirred evenly. A mixture of catalyst and dehydrating agent was added to the mixed solution, and the mixture was composed of 2.2 g of AA and 2.1 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### COMPARATIVE EXAMPLE 5

1.1 g of PDA and 3.6 g of TPER were added to 49.2 g of solvent DMAc, stirred and dissolved evenly, and then 1.2 g of PMDA and 4.9 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 32.4 g of soluble liquid crystal polymer slurry and 21.1 g of insoluble liquid crystal polymer powder with 10% solid content were mixed and stirred evenly. A mixture of catalyst and dehydrating agent was added to the mixed solution, and the mixture was composed of 2.3 g of AA and 2.1 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### COMPARATIVE EXAMPLE 6

1.1 g of PDA and 3.6 g of TPER were added to 49.2 g of solvent DMAc,

stirred and dissolved evenly, and then 1.2 g of PMDA and 4.9 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 3.6 g of soluble liquid crystal polymer slurry and 0.54 g of insoluble liquid crystal polymer powder with 10% solid content were mixed and stirred evenly. A mixture of catalyst and dehydrating agent was added to the mixed solution, and the mixture was composed of 2.3 g of AA and 2.1 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. for 60 minutes before forming.

### COMPARATIVE EXAMPLE 7

1.1 g of PDA and 3.6 g of TPER were added to 49.2 g of solvent DMAc,

stirred and dissolved evenly, and then 1.2 g of PMDA and 4.9 g of BPDA were added, the reaction temperature was controlled at 25° C., the reactants were continuously stirred for 2-3 hours, and the viscosity was fine-tuned with a trace amount of BPDA, and finally 60 g of polyimide precursor with 18.0% solid content and viscosity of 160000±40000 cps. was obtained. 15.0 g of polyimide precursor, 93.3 g of soluble liquid crystal polymer slurry and 3.2 g of insoluble liquid crystal polymer powder with 20% solid content were mixed and stirred evenly. A mixture of catalyst and dehydrating agent was added to the mixed solution, and the mixture was composed of 2.3 g of AA and 2.1 g of AP, and finally an adhesive composition with a total solid content of 20% was obtained. After the aforementioned adhesive composition was evenly mixed, it was defoamed by centrifugation, coated on a substrate, and baked at 60-80° C. for 40-120 minutes to form a gel heat-resistant liquid crystal polymer film, and then the gel heat-resistant liquid crystal polymer film was taken from the substrate and fixed on a metal frame, and then baked at a temperature raised to 300° C. 10 for 60 minutes before forming.

TABLE 1
The combination of polyimide ingredients used

| | | | | | | | | | | diamine | |
|---|---|---|---|---|---|---|---|---|---|---|---|
| | | | | | | BPDA | PMDA | PDA | TPER | C | |
| polyimide | dianhydride | dianhydride | diamine | diamine | diamine | molar | molar | molar | molar | molar | |
| combination | A | B | A | B | C | ratio | ratio | ratio | ratio | ratio | Tg |
| A1 | BPDA | PMDA | PDA | TPER | — | 65 | 35 | 55 | 45 | — | 310 |
| A2 | BPDA | PMDA | PDA | TPER | — | 75 | 25 | 45 | 55 | — | 306 |
| A3 | BPDA | PMDA | PDA | TPER | TFMB | 65 | 35 | 40 | 20 | 40 | 341 |
| A4 | BPDA | PMDA | PDA | TPER | 4,4′- | 65 | 35 | 60 | 20 | 20 | 320 |
| | | | | | ODA | | | | | | |
| B1 | BPDA | PMDA | PDA | TPER | | 85 | 15 | 55 | 45 | — | 270 |
| B2 | BPDA | PMDA | PDA | TPER | mTB | 18 | 82 | 53 | 32 | 15 | 330 |
| B3 | BPDA | PMDA | PDA | TPER | | 65 | 35 | 65 | 35 | — | 323 |
| B4 | BPDA | PMDA | PDA | TPER | ODA | 65 | 35 | 27 | 53 | 20 | 240 |

TABLE 2
Composition and characteristics of the heat-resistant liquid crystal polymer film

| | insoluble | soluble | | | Df @ 10G | Df @ 10G | | | | |
|---|---|---|---|---|---|---|---|---|---|---|
| | liquid | liquid | | | Hz | Hz | | | | |
| | crystal | crystal | | | 65% RH | 100% RH | | | | moisture |
| | polymer | polymer | polyimide | polyimide | of | of | CTE | | E′ | absorption |
| | wt % | wt % | wt % | combination | humidity | humidity | (50-200° C.) | Tg | (310° C.) | rate % |
| E1 | 45 | 20 | 35 | A1 | 0.0033 | 0.0045 | 15 | 256 | 0.25 | 0.45 |
| E2 | 45 | 20 | 35 | A2 | 0.0034 | 0.0040 | 17 | 252 | 0.23 | 0.41 |
| E3 | 45 | 20 | 35 | A3 | 0.0036 | 0.0048 | 9 | 285 | 0.40 | 0.48 |
| E4 | 45 | 20 | 35 | A4 | 0.0034 | 0.0046 | 10 | 270 | 0.30 | 0.47 |
| E5 | 20 | 40 | 40 | A3 | 0.0038 | 0.0044 | 19 | 290 | 0.41 | 0.49 |
| E6 | 67 | 15 | 18 | A3 | 0.0025 | 0.0030 | 18 | 248 | 0.21 | 0.38 |
| CE1 | 45 | 20 | 35 | B1 | 0.0033 | 0.0041 | 28 | 210 | 0.13 | 0.40 |
| CE2 | 45 | 20 | 35 | B2 | 0.0072 | 0.0080 | 19 | 305 | 0.43 | 0.71 |
| CE3 | 45 | 20 | 35 | B3 | 0.0054 | 0.0061 | 18 | 262 | 0.28 | 0.57 |
| CE4 | 45 | 20 | 35 | B4 | 0.0036 | 0.0043 | 29 | 215 | 0.11 | 0.41 |
| CE5 | 78 | 12 | 10 | A2 | 0.0021 | 0.0025 | 19 | 280 | 0.02 | 0.04 |
| CE6 | 15 | 10 | 75 | A2 | 0.0065 | 0.0085 | 8 | 290 | 0.45 | 0.90 |
| CE7 | 13 | 76 | 11 | A2 | 0.0040 | 0.0045 | 40 | 206 | 0.04 | 0.53 |

Regarding Embodiments 1-6: Because Embodiments 1-6 use specific polyimide, soluble liquid crystal polymer and insoluble liquid crystal polymer with a specific proportion, the heat-resistant liquid crystal polymer films made by the Embodiments have the moisture absorption, dielectric loss (Df), linear thermal expansion coefficient (CTE), storage modulus (E′) and glass transition temperature (Tg) and the like that the present disclosure intends to achieve, and meets the needs of the present disclosure.

Regarding Comparative example 1: In the polyimide combination B1, because pyromellitic dianhydride (PMDA) is less than 20 mol % relative to the total dianhydride, the heat-resistant liquid crystal polymer film made by Comparative example 1 has a linear thermal expansion coefficient (CTE) greater than 20, a glass transition temperature (Tg) less than 220° C., and a storage modulus (E′) at 310° C. less than 0.2, which fails to meet the requirements of the present disclosure.

Regarding Comparative example 2: In the polyimide combination B2, because the total pyromellitic dianhydride (PMDA) is greater than 80 mol % relative to the total dianhydride, the heat-resistant liquid crystal polymer film made by Comparative example 2 has a dielectric loss greater than 0.005 under the condition of 100% RH and a water absorption rate greater than 0.5%, which fails to meet the requirements of the present disclosure.

Regarding Comparative example 3: In the polyimide combination B3, because the p-phenylenediamine (PDA) is greater than 60 mol % relative to total diamine, the heat-resistant liquid crystal polymer film made by Comparative example 3 has a dielectric loss greater than 0.005 under the condition of 100% RH and a water absorption rate greater than 0.5%, which fails to meet the requirements of the present disclosure.

Regarding Comparative example 4: In the polyimide combination B4, because the p-phenylenediamine (PDA) is less than 40 mol % relative to total diamine, the heat-resistant liquid crystal polymer film made by Comparative example 3 has a linear thermal expansion coefficient (CTE) greater than 20 and a glass transition temperature (Tg) less than 220° C., which fails to meet the requirements of the present disclosure.

Regarding Comparative example 5: Because the insoluble liquid crystal polymer accounts for 75 wt % or more of the total heat-resistant liquid crystal polymer film, the heat-resistant liquid crystal polymer film made by Comparative example 5 has a storage modulus at 310° C. less than 0.2, which fails to meet the requirements of the present disclosure.

Regarding Comparative example 6: Because the polyimide accounts for 50 wt % or more of the total heat-resistant liquid crystal polymer film, the heat-resistant liquid crystal polymer film made by Comparative example 6 has a dielectric loss greater than 0.005 under the condition of 100% RH and a water absorption rate greater than 0.5%, which fails to meet the requirements of the present disclosure.

Regarding Comparative example 7: Because the soluble liquid crystal polymer accounts for 75 wt % or more of the total heat-resistant liquid crystal polymer film, the heat-resistant liquid crystal polymer film made by Comparative example 7 has a linear thermal expansion coefficient greater than 20, a storage modulus at 310° C. less than 0.2, a water absorption rate greater than 0.5% and a glass transition temperature (Tg) less than 220° C., which fails to meet the requirements of the present disclosure.

The content of the above specific embodiments is intended to elaborate on the present invention, however, such embodiments are for illustrative purposes only and are not intended to limit the present invention. Those skilled in the art can understand various variations and modifications that could be made to the present invention without departing from the scope defined by the attached claims fall into a part of the present invention.

While the present disclosure has been described by means of specific embodiments, numerous modifications and variations could be made thereto by those skilled in the art without departing from the scope and spirit of the present disclosure set forth in the claims.

What is claimed is:

1. A heat-resistant liquid crystal polymer film, comprising:
a soluble liquid crystal polymer, accounting for 15-75 wt % of the heat-resistant liquid crystal polymer film;
an insoluble liquid crystal polymer, accounting for 15-75 wt % of the heat-resistant liquid crystal polymer film; and
a polyimide, composed of dianhydride and diamine, accounting for 10-50 wt % of the heat-resistant liquid crystal polymer film, and the polyimide has a glass transition temperature (Tg) greater than 250° C.;
wherein the heat-resistant liquid crystal polymer film has a moisture absorption less than 0.5%; under the condition of frequency of 10 GHz and humidity of 65% RH, the heat-resistant liquid crystal polymer film has a dielectric loss (Df) less than 0.005; as well as
under the condition of 50-200° C., the heat-resistant liquid crystal polymer film has a linear thermal expansion coefficient (CTE) less than 20 ppm/° C.;
under the condition of 310° C., the heat-resistant liquid crystal polymer film has a storage modulus (E′) greater than 0.2 Gpa; and
the heat-resistant liquid crystal polymer film has a glass transition temperature (Tg) greater than 220° C.

2. The heat-resistant liquid crystal polymer film according to claim 1, wherein the polyimide accounts for 10-40 wt % of the heat-resistant liquid crystal polymer film, under the condition of frequency of 10 GHz and humidity of 100% RH, the heat-resistant liquid crystal polymer film has a dielectric loss (Df) less than 0.005.

3. The heat-resistant liquid crystal polymer film according to claim 1, wherein the dianhydride comprises pyromellitic dianhydride (PMDA) and the diamine comprises p-phenylenediamine (PDA), wherein the pyromellitic dianhydride (PMDA) accounts for 20-80 mol % relative to the total dianhydride, the p-phenylenediamine (PDA) accounts for 40-60 mol % relative to the total diamine.

4. The heat-resistant liquid crystal polymer film according to claim 3, wherein the dianhydride further comprises 3,3′,4,4′-biphenyl tetracarboxylic dianhydride (BPDA).

5. The heat-resistant liquid crystal polymer film according to claim 3, wherein the diamine further comprises at least one selected from the group consisting of 1,3-bis(4′-aminophenoxy)benzene (TPER), 1,4-bis (4-aminophenoxy) benzene (TPEQ), 2,2′-bis [4-(4-aminophenoxyphenyl)]propane (BAPP), 4,4′-bis(4-aminophenoxy)biphenyl (BAPB), 1,3-bis(3-aminophenoxy)benzene (APBN), p-aminophenyl p-aminobenzoate (APAB), 2,2′-bis(trifluoromethyl)diaminobiphenyl (TFMB) and 4,4′-diaminodiphenyl ether (4,4′-ODA).
